(19) United States
(12) Patent Application Publication
(10) Pub. No.: US 2020/0125990 A1
(43) Pub. Date: Apr. 23, 2020

(54) Systems and Methods for Intervention Optimization

(71) Applicant: Google LLC, Mountain View, CA (US)

(72) Inventors: John Burge, Santa Clara, CA (US); Benjamin Frenkel, Santa Clara, CA (US); Craig Edgar Boutilier, Palo Alto, CA (US); Victor Lum, San Mateo, CA (US); Yi-Lun Ruan, Palo Alto, CA (US); Jumana Al Hashal, San Francisco, CA (US); Hamid Mousavi, Mountain View, CA (US); Subir Jhanb, Cupertino, CA (US); Viren Baraiya, Cupertino, CA (US); Aditya Gautam, Menlo Park, CA (US)

(21) Appl. No.: 16/262,223

(22) Filed: Jan. 30, 2019

Related U.S. Application Data
(60) Provisional application No. 62/749,420, filed on Oct. 23, 2018.

(51) Int. Cl. G06N 20/00; G06N 5/04

(52) U.S. Cl. CPC G06N 20/00; G06N 5/045

(57) ABSTRACT

The present disclosure provides systems and methods for intervention optimization. A computing system obtain an entity history of each of a plurality of entities of a computer application. For each of the plurality of entities, the computing system can determine a respective probability that each of a plurality of available interventions will improve an objective value that is determined based at least in part on a measure of continued use of a computer application by the entity. The computing system can provide interventions of the plurality of available interventions to entities of the plurality of entities based at least in part on the respective probabilities determined via the machine-learned intervention selection model. Thus, a computing system can employ a machine-learned intervention selection model to select, on an entity-by-entity basis, interventions that are predicted to prevent the entity from churning out of the computer application.

### PRIORITY CLAIM

The present application is based on and claims priority to U.S. Provisional Application No. 62/749,420 having a filing date of Oct. 23, 2018. Applicant claims priority to and the benefit of each of such application and incorporate all such application herein by reference in its entirety.

### FIELD

The present disclosure relates generally to machine learning techniques. More particularly, the present disclosure relates to systems and methods for intervention optimization.

### BACKGROUND

Application developers such as, for example, website developers, mobile application developers, game developers, etc., often have the goal of maximizing the number of entities that use their application. As an example, for various reasons, a game developer may seek to maximize the numbers of users that play the game she developed on a daily basis.

As such, one concern of application developers is that of user “churn.” In particular, “churn” refers to the scenario where an existing user of a computer application ceases or otherwise significantly reduces use of such application. User churn is often measured as a “churn rate” or attrition rate (e.g., percent of existing users that leave the game over a period of time such as a month). Thus, a game developer that seeks to maximize the numbers of users that play her game will, conversely, seek to minimize user churn.

Churn is highly related to “user retention.” Churn can include the event when a user stops engaging with an application while retention is how long a user stays in an application. Thus, churn is an event that impacts user retention. Combatting user churn is one technique to increase user retention. Various other indicators of user engagement exist in addition to churn and user retention and each of these indicators may measure some aspect of continued use of the application by a user.

One technique to combat user churn or otherwise increase user engagement is through the use of interventions. An intervention can include an action and/or operational change by the developer and/or the application taken with respect to one or more users (e.g., with the goal of preventing user churn). However, identifying for which users an intervention should be performed and, for such identified users, which intervention should be performed is a challenging task.

### SUMMARY

Aspects and advantages of embodiments of the present disclosure will be set forth in part in the following description, or can be learned from the description, or can be learned through practice of the embodiments.

One example aspect of the present disclosure is directed to a computing system. The computing system can include one or more processors, one or more non-transitory computer-readable media that collectively store: a machine-learned intervention selection model configured to select interventions on an entity-by-entity basis based at least in part on respective entity histories associated with entities, and instructions that, when executed by the one or more processors, cause the computing system to perform operations. The operations can include obtaining a entity history of each of a plurality of entities of a computer application. The operations can further include for each of the plurality of entities, determining, via the machine-learned intervention selection model based at least in part on the entity history for each entity, a respective probability that each of a plurality of available interventions will improve an objective value that is determined based at least in part on a measure of continued use of the computer application by the entity. The operations can further include providing one or more interventions of the plurality of available interventions to one or more entities of the plurality of entities based at least in part on the respective probabilities determined via the machine-learned intervention selection model.

Another example aspect of the present disclosure is directed to a computer-implemented method. The computer-implemented method can include obtaining, by one or more computing devices, entity history data associated with an entity associated with a computer application. The method can further include inputting, by the one or more computing devices, the entity history data into a machine-learned intervention selection model that is configured to process the entity history data to select one or more interventions from a plurality of available interventions. The method can further include receiving, by the one or more computing devices, a selection of the one or more interventions by the machine-learned intervention selection model based at least in part on the entity history data. The method can further include in response to the selection, performing, by the one or more computing devices, the one or more interventions for the entity.

Another example aspect of the present disclosure is directed to one or more non-transitory computer-readable media that store instructions that, when executed by one or more computing devices, cause the one or more computing devices to perform operations. The operations can include obtaining entity history data associated with an entity associated with a computer application. The operations can further include inputting the entity history data into a machine-learned intervention selection model that is configured to process the entity history data to select one or more interventions from a plurality of available interventions, wherein at least some of the plurality of available interventions are defined by a developer of the computer application. The operations can further include receiving a selection of the one or more interventions by the machine-learned intervention selection model based at least in part on the entity history data, wherein the machine-learned intervention selection model is configured to make the selection of the one or more interventions to optimize an objective function, wherein the objective function measures entity engagement with the computer application. The operations can further include in response to the selection, performing the one or more interventions for the entity within the computing application.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs intervention optimization according to example embodiments of the present disclosure.

FIG. 1B depicts a block diagram of an example computing device that performs intervention optimization according to example embodiments of the present disclosure.

FIG. 1C depicts a block diagram of an example computing device that performs intervention optimization according to example embodiments of the present disclosure.

FIG. 2 depicts a flow chart diagram of an example method to perform intervention optimization according to example embodiments of the present disclosure.

FIG. 3 depicts a block diagram of an example infrastructure of machine-learned intervention selection model according to example embodiments of the present disclosure.

Reference numerals that are repeated across plural figures are intended to identify the same features in various implementations.

### DETAILED DESCRIPTION

### Overview

Example aspects of the present disclosure are directed to systems and methods for intervention optimization. In particular, in some implementations, to reduce user churn, the systems and methods of the present disclosure can include or otherwise leverage a machine-learned intervention selection model that is configured to select interventions on a entity-by-entity basis based at least in part on respective entity histories associated with entities. In particular, a computing system (e.g., application server) can obtain an entity history of each of a plurality of entities associated with a computer application. For each of the plurality of entities, the computing system can determine, via the machine-learned intervention selection model and based at least in part on the entity history for each entity, a respective probability that each of a plurality of available interventions will improve an objective value. For example, the objective value may be determined based at least in part on a measure of continued use of a computer application by the entity and/or on other objectives. The computing system can provide one or more interventions of the plurality of available interventions to one or more entities of the plurality of entities based at least in part on the respective probabilities determined via the machine-learned intervention selection model. Thus, a computing system can employ a machine-learned intervention selection model to select, on an entity-by-entity basis, one or more interventions that are predicted to prevent the entity from churning out of a computer application (e.g., a mobile application, a web browser application or website, or a game application). In some implementations, the selected interventions can be automatically performed, thereby greatly reducing the workload for application developers while also reducing user churn or otherwise improving other measures of user engagement.

More particularly, aspects of the present disclosure are directed to reducing user churn out of a computer application and/or addressing other objectives including custom developer-specified objectives. As used herein, the term “application” broadly includes various different computer programs, software, and/or systems. One example application is a mobile application such as, for example, a text messaging application installed on a mobile device (e.g., smartphone). A developer or other individual or organization involved with providing the mobile application may seek to maximize the number of entities (e.g., daily users) of the mobile application or, stated differently, may seek to minimize user churn out of the mobile application. Another example of a computer application is a website. For example, a website owner may seek to maximize the number of entities that “visit” or otherwise interact with her website on a periodic basis (e.g., daily, weekly, etc.). Another example of a computer application is a computer game (e.g., a mobile game, a game for a dedicated gaming console, a massively multiplayer online game, a browser game, a game embedded in a social media platform, an augmented or virtual reality game, etc.). Another example application may be a traditional computer application executed on a desktop, laptop, tablet, or the like.

An application can have a number of entities that use the application. For example, entities can include specific individual users, groups of one or more users, an account associated with the application (e.g., an individual account or an account shared by one or more users such as a corporate account), an organization that uses the application, or any other entity with which data included in the application is associated (e.g., an IP address, a geolocation, a business listing, and/or other entities). Although portions of the present disclosure focus for the purpose of explanation on application of aspects of the systems and methods described herein to individual users, all such aspects are equally applicable to operate on basis of entities, rather than specific users, as described above.

According aspects of the present disclosure, a computing system can interact with the computer application to prevent user churn out of the application and/or in furtherance of other objectives such as increasing an allocation of user resources (e.g., time, currency such as virtual currency, computing resources, etc.) into the application. To fulfil these objectives, the computing system can operate to automatically intervene in the computer application on a user-by-user basis based on user histories associated with the users.

In particular, the computing system can obtain a user history of each of a plurality of users of a computer application. For example, the computing system can obtain a history of events associated with the user in the computer application. The events can be events that the user triggered or events that were performed by or on behalf of the user. In some implementations, the history of events can be chronologically sorted. In some implementations, the user history can also include other contextual information (e.g., associated with certain events), such as, for example, time, current application state of the user's device, and/or other information regarding the user for which the user has consented that the application may use (e.g., user location). Thus, in some implementations, user history data for each user of a computer application can be a history of events that the user triggered or performed in the computer application, which may include a ‘time series’ of chronologically sorted events for that user.

According to an aspect of the present disclosure, for a particular user and based on the user history associated with that user, the computing system can determine whether to perform an intervention with respect to the user and, if so, which intervention should be performed. In particular, the computing system can select one or more interventions from a plurality of available interventions that the system can perform. As examples, interventions can include changes to operational parameters of the application itself (e.g., a change to the behavior and/or appearance of the application) or can include interventions that are related to the application but do not necessarily change the operational parameters of the application itself (e.g., sending a user a notification that they have remaining levels of a game to play). The interventions can be binary (e.g., send a notification or not) or can be scalar (e.g., increase hit point requirement for game boss from 89 to 92).

In some implementations, some or all of the available interventions that the system can perform can be specified by the developer or other party associated with the application. As examples, for an example gaming application, the developer might specify a set of interventions which include: 1) give free in-game object (e.g., battle axe, enhanced player attribute, etc.), 2) make game level easier to pass for a time period, 3) don't show any external content, 4) show twice as much external content, or other interventions. Thus, the developer can provide specific input that controls which interventions can be performed by the computing system. The developer can also specify various rules and/or relationships that control characteristics of the system's use of the intervention such as how frequently an intervention can be performed, how many interventions can be performed for a given user, which interventions can or cannot be performed at the same time, a maximum number of interventions per time period, and/or similar information.

Thus, in some implementations, the computing system can include a user interface and backend that allows developers to provide the set of interventions. In one example, the user interface can include intervention name, remote configuration parameters to enable/disable the intervention, valid values, acceptable frequency, and/or an identification of objectives (e.g., revenue, retention, custom).

In some implementations, the computing system can input the user history into a machine-learned intervention selection model. The machine-learned intervention selection model can provide a respective probability that each of the plurality of available interventions will improve an objective value that is determined based at least in part on a measure of continued use of the computer application by the user. Thus, the machine-learned intervention selection model can compute a respective probability that each of the plurality of available interventions will improve retention based on respective history of events associated with users. In some implementations, in addition to the measure of continued use of the computer application by the user, the objective value is further determined based at least in part on an allocation of resources by the user within the computer application. For example, the machine-learned intervention selection model can compute a respective probability that each of the plurality of available interventions will enable users to allocate resources in the computer application based on respective history of events associated with users.

More specifically, in some implementations, the machine-learned intervention selection model can provide predictions which correspond to the following values:

P(C=yes|T,I₀=yes), P(C=yes|T,I₁=yes), P(C=yes|T,I₂=yes) . . . P(C=yes|T,I_{N}=yes),

where C is whether the user has churned out of the computer application, T the time series for the user, and I is a possible intervention the developer could take to reduce the chance that a user will churn. The I₀ intervention is the ‘null intervention’ in which the application's default behavior is given. Once each of these probabilities is computed, the computing system can select the intervention with the lowest probability of churn for the user and can then automatically apply the selected intervention to that user. That is, in some implementations, if the system has N possible interventions (including the null intervention), the system can choose and apply an invention according to the following example expression:

Argminᵢ(P(C=yes|T,Iᵢ)),0≤i≤N.

In some implementations, the machine-learned intervention selection model can be trained and operate according to a reinforcement learning scheme. For example, the machine-learned intervention selection model can be or include an intervention agent in a reinforcement learning scheme. For example, the intervention agent can apply a policy to select certain actions (e.g., interventions) based on a current state and can receive a respective reward associated with an outcome of each action. The computing system can optimize the machine-learned intervention selection model based on the respective rewards to improve the policy of the intervention agent.

More particularly, in some implementations, the intervention agent can receive the current user history for a particular user and can treat such user history as the state. Based on the state, the intervention can select one or more actions to perform, where actions describe how one or more interventions are applied to users. The actions can be single actions or strings of actions. For example, a first action can indicate that a first intervention is applied today, a second action can indicate that a second intervention will be applied in three days, and a third action can indicate that a third intervention will be applied in five days. Based on an outcome of the actions, the intervention agent can receive a reward. For example, the reward can be determined using the objective function, where the objective function measures user churn or other characteristics of user engagement. The computing system can update or modify the policy of the intervention agent based on the received reward, thereby leading to an improved policy that enables the intervention selection model to select an intervention that can give the highest reward in subsequent interventions.

In some implementations, in addition or alternatively to the use of reinforcement learning, the machine-learned intervention selection model can be trained using supervised learning techniques. For instance, the computing system can train the intervention selection model based on training data. The training data can include a set of user histories and interventions that were selected based on such user histories. The training data can include a respective ground-truth label for each pair of user history/intervention that describes a known outcome that occurred after the intervention. In some implementations, the computing system can train the intervention selection model using various training or learning techniques, such as, for example, backwards propagation of errors. In some implementations, performing backwards propagation of errors can include performing truncated backpropagation through time.

In some implementations, the computing system can operate to perform exploration versus exploitation of intervention strategies. More particularly, in order to know the impact of an intervention, the system typically needs to have data that describes the impact of that intervention applied to users in the wild. Thus, to compute the impact of all the interventions, the system can operate to trigger these interventions before the impact of doing so is explicitly known. This assists in learning when each intervention should be applied.

In particular, in some instances, instead of computing the respective probabilities for the interventions, the computing system can randomly provide one or more of the plurality of available interventions to users during an exploratory time period (also referred to as an exploration stage). As one example, the computing system can randomly give the one or more interventions to users in the computer application for some period of time, e.g., for a week. As another example, the computing system can randomly give a first intervention of the one or more interventions to users for a first time period, e.g., several hours in a specific date. The computing system can randomly give a second intervention of the one or more interventions to users for a second time period, e.g., 4 days a week. The computing system can randomly give a third intervention of the one or more interventions to users for a third time period after the first and second interventions applied to users, e.g., 5 days after the first and the second interventions applied to users. By observing the outcomes of these exploratory interventions, the computing system can better assess subsequent opportunities to intervene in the computer application. The exploration period can be developer-defined and/or can be performed by the computing system according to various optimization techniques such as one or more multi-armed bandit techniques. Example multi-armed bandit techniques include optimal solutions, approximate solutions (e.g., semi-uniform strategies such as epsilon-greedy strategy, epsilon-first strategy, epsilon-decreasing strategy, probability matching strategies, pricing strategies, etc.), contextual bandit solutions, adversarial bandit solutions, infinite-armed bandit solutions, non-stationary bandit solutions, and other variants.

As described above, not all interventions that are defined in the system can be used at every single instance. For example, developer-defined rules can prevent recurring usage of particular intervention. For example, if the intervention is sending out a notification, then the system may be constrained to only send one notification per certain time period (e.g., 48 hours). As such, in some implementations, the computing system can identify which of a plurality of defined interventions are available at a particular time. The plurality of available interventions can be a subset of the plurality of defined interventions that satisfy one or more developer-supplied intervention criteria and/or other rules at a time of selection. The machine-learned intervention selection model or the system that executes upon its predictions can be configured to select only available interventions for use.

In some implementations, the machine-learned intervention selection model can be located within a server computing device that serves the computer application. For instance, the server computing system can include the intervention selection model and provide the selected interventions to the computer application that can be installed on a user computing device according to a client-server architecture.

In other implementations, the machine-learned intervention selection model can be located within the computer application on a user computing device. For instance, the user computing device can include the computer application having the model to select the interventions.

In yet other implementations, the machine-learned intervention selection model can be located on the user computing device with the computer application but can be external to the application. For example, the machine-learned intervention selection model can serve multiple different applications on the user computing device according to a client-server architecture.

In some implementations, the computing system can include a software developer kit (SDK) for sending user-activity-events from a computing device that executes the application (e.g., a user device such as a mobile device) to a server computing system (e.g., a production server). The server computing system can receive events and collate the events into a time series and can then store those events for each user. The computing system can include a machine learning system that trains the machine-learned intervention selection model based on all the time series. The computing system can take the trained machine-learned intervention selection model and can perform intervention predictions on one or more users, and can then store those predictions as well as selected interventions. The computing system can fetch a stored prediction when the computer application needs to know which intervention to apply. The computing system can include a feedback system that can record when each intervention was taken and record the selected interventions that will be applied to users. The computing system can also include a user interface and backend that allows developers to provide the set of interventions.

While the computing system described herein is primarily described with respect to selection of interventions on a user-by-user basis, in some implementations, the computing system can alternatively or additionally select interventions for groups of multiple users (e.g., groups of users that are positives or negatives of a single prediction). For instance, the computing system can use the machine-learned intervention selection model to select one or more interventions that are predicted to get a group of users associated with positives to stay in the computer application. In some implementations, the computing system can allow developers to have some coarse-grained control over predictions (e.g., either with current risk profiles, or with other proposed-but-not-launched features) and can allow the developers to target different subsets of either the positives or negatives. In some implementations, the computing system can allow developers to, for example, potentially target different causes of churn differently.

Thus, the present disclosure provides systems and methods that optimize interventions to improve user in a computer application. The provided system removes the need for developers to explicitly take action on predictions regarding churn. Instead, developers just provide a list of interventions, and the system will learn when and to whom these interventions should be applied to maximize retention, resource allocation, or some custom optimization function which takes into account a number of different objectives.

The present disclosure provides a number of technical effects and benefits. As one example technical effect and benefit, in some implementations, the systems and methods of the present disclosure can select one or more interventions that are predicted to improve retention or allocation of resources on a user-by user basis. Thus, interventions can be performed with improved accuracy and efficacy because they are selected specifically for a particular user. This improved efficacy can result in fewer interventions overall, as a single intervention is more likely to obtain the desired result. The use of fewer interventions overall can save computing resources such as processor usage, memory usage, and/or network bandwidth usage, as fewer intervention actions—which are require use of computing resources—are required to be performed overall.

As another example technical effect and benefit, the systems and methods of the present disclosure can provide an exploration stage prior to applying the machine-learned intervention selection model. The exploration stage can solve difficulties with computing probabilities where data does not exist that enables training the machine-learned intervention selection model to accurately predict the probabilities. As such, the exploration stage can improve prediction accuracy of the machine-learned intervention selection model.

As yet another example technical effect and benefit, the computing system can allow developers to provide a set of interventions, and the computing system can provide a prediction for each intervention to developers to let them know which intervention is most likely to get users to stay in the computer application, and/or to get users to allocate resources to the computer application. As such, the computing system can help developers to collect information associated with the interventions provided by the developers and to utilize the collected information to improve interventions for increasing retention and/or allocation of resources of the computing application.

With reference now to the Figures, example embodiments of the present disclosure will be discussed in further detail.

### Example Devices and Systems

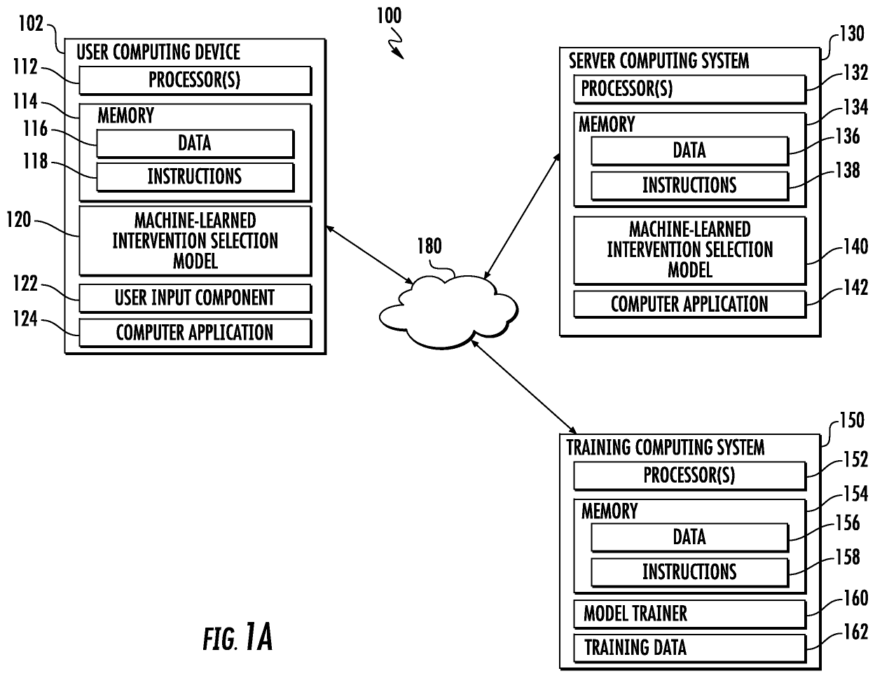

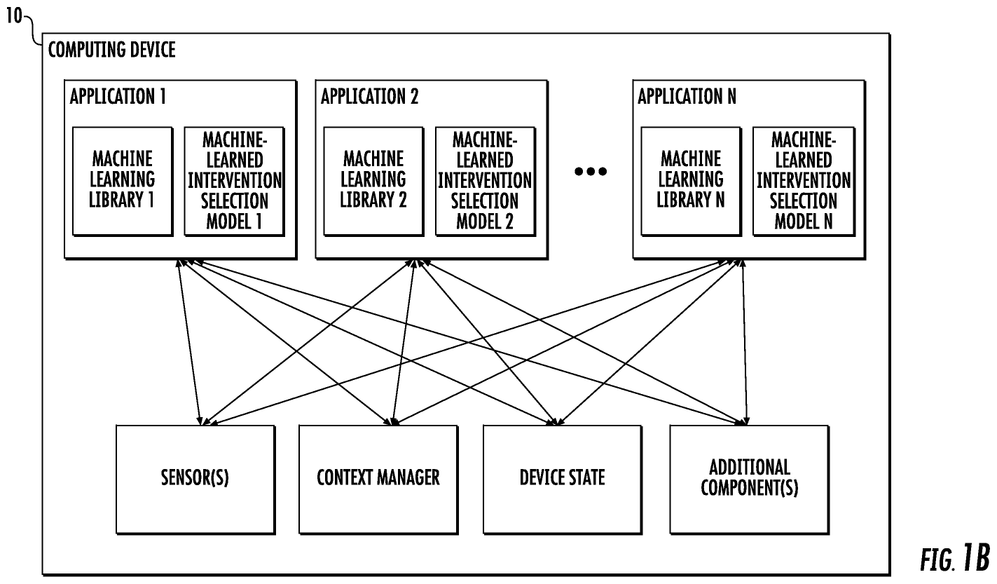

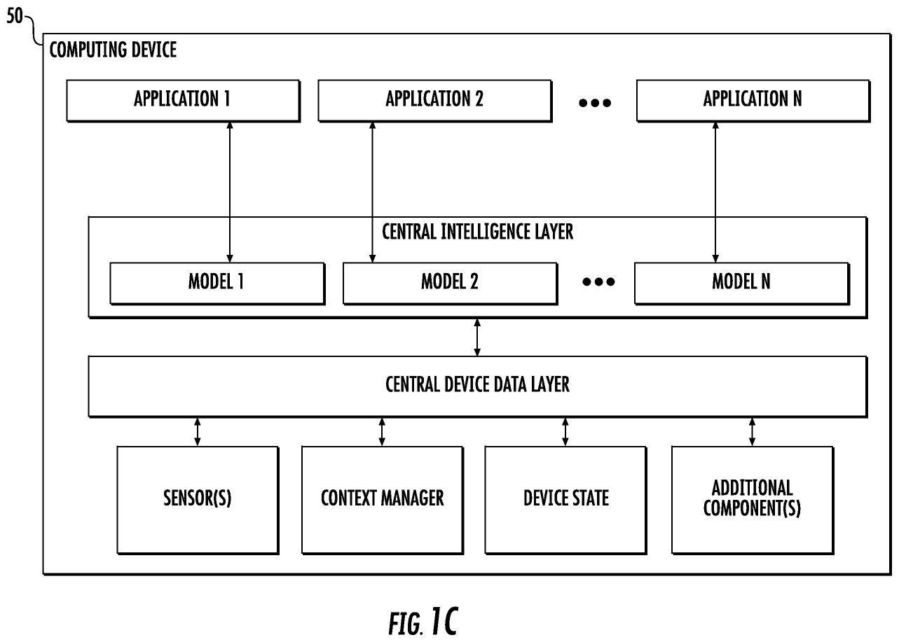

FIG. 1A depicts a block diagram of an example computing system 100 that performs intervention optimization according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

The user computing device 102 can store or include one or more machine-learned intervention selection models 120. For example, the machine-learned intervention selection models 120 can be or can otherwise include various machine-learned models such as neural networks (e.g., deep neural networks) or other multi-layer non-linear models. Neural networks can include recurrent neural networks (e.g., long short-term memory recurrent neural networks), feed-forward neural networks, or other forms of neural networks. The machine-learned intervention selection models 120 can include other types of models as well such as, for example, decision tree-based models (e.g., random forests), support vector machines, various types of classifier models, linear models, and/or other types of models.

In some implementations, the one or more machine-learned intervention selection models 120 can be received from the server computing system 130 over network 180, stored in the user computing device memory 114, and the used or otherwise implemented by the one or more processors 112. In some implementations, the user computing device 102 can implement multiple parallel instances of a single machine-learned intervention selection model 120 (e.g., to perform parallel intervention optimization across multiple instances of intervention optimization).

More particularly, the machine-learned intervention selection model can provide a respective probability that each of the plurality of available interventions will improve an objective value that is determined based at least in part on a measure of continued use of the computer application by the user. Thus, the machine-learned intervention selection model can compute a respective probability that each of the plurality of available interventions will improve retention based on respective history of events associated with users. In some implementations, in addition or alternatively to the measure of continued use of the computer application by the user, the objective value is further determined based at least in part on an allocation of resources by the user within the computer application. For example, the machine-learned intervention selection model can compute a respective probability that each of the plurality of available interventions will enable users to allocate resources in the computer application based on respective history of events associated with users. Additional example objectives can be specified as well, including custom developer-specified objectives. As one example, in a gaming application that has both solo and multiplayer game modes, the developer might want to encourage users to play multiplayer games. As such, the developer can specify a custom objective that measures usage of the multiplayer mode. In such fashion, interventions can be automatically performed which result in increased usage of the multiplayer mode. In instances where multiple objectives are specified, the respective weightings between objectives can be developer-specified or can be learned.

As one example, in some implementations, the machine-learned intervention selection model can provide predictions which correspond to the following values:

P(C=yes|T,I₀=yes), P(C=yes|T,I₁=yes), P(C=yes|T,I₂=yes) . . . P(C=yes|T,I_{N}=yes),

where C is whether the user has churned out of the computer application, T the time series for the user, and I is a possible intervention the developer could take to reduce the chance that a user will churn. The I₀ intervention is the ‘null intervention’ in which the application's default behavior is given. Once each of these probabilities is computed, the computing system can select the intervention with the lowest probability of churn for the user and can then automatically apply the selected intervention to that user. That is, in some implementations, if the system has N possible interventions (including the null intervention), the system can choose and apply an invention according to the following example expression:

Argminᵢ(P(C=yes|T,Iᵢ)),0≤i≤N.

In other implementations, instead of minimizing the probability of user churn, the system can choose and apply an invention according to an expression that measures the probability that each intervention will increase an objective value that measures satisfaction of a number of different objectives.

In some implementations, the machine-learned intervention selection model can be trained and operate according to a reinforcement learning scheme. For example, the machine-learned intervention selection model can be or include an intervention agent in a reinforcement learning scheme. For example, the intervention agent can apply a policy to select certain actions (e.g., interventions) based on a current state and can receive a respective reward associated with an outcome of each action. The computing system can optimize the machine-learned intervention selection model based on the respective rewards to improve the policy of the intervention agent.

More particularly, in some implementations, the intervention agent can receive the current user history for a particular user and can treat such user history as the state. Based on the state, the intervention can select one or more actions to perform, where actions describe how one or more interventions are applied to users. The actions can be single actions or strings of actions. For example, a first action can indicate that a first intervention is applied today, a second action can indicate that a second intervention will be applied in three days, and a third action can indicate that a third intervention will be applied in five days. Based on an outcome of the actions, the intervention agent can receive a reward. For example, the reward can be determined using the objective function, where the objective function measures user churn or other characteristics of user engagement. The computing system can update or modify the policy of the intervention agent based on the received reward, thereby leading to an improved policy that enables the intervention selection model to select an intervention that can give the highest reward in subsequent interventions.

In some implementations, in addition or alternatively to the use of reinforcement learning, the machine-learned intervention selection model can be trained using supervised learning techniques, as further described in training computing system 150.

Additionally or alternatively, one or more machine-learned intervention selection models 140 can be included in or otherwise stored and implemented by the server computing system 130 that communicates with the user computing device 102 according to a client-server relationship. For example, the machine-learned intervention selection models 140 can be implemented by the server computing system 140 as a portion of a web service (e.g., an intervention optimization service). Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can enter a communication.

The user computing device 102 can also include a computer application 124. The computer application 124 can include various different computer programs, software, and/or systems. One example application is a mobile application such as, for example, a text messaging application installed on a mobile device (e.g., smartphone). A developer or other entity involved with providing the mobile application may seek to maximize the number of users (e.g., daily users) of the mobile application or, stated differently, may seek to minimize user churn out of the mobile application. Another example of a computer application is a website. For example, a website owner may seek to maximize the number of users that “visit” or otherwise interact with her website on a periodic basis (e.g., daily, weekly, etc.). Another example of a computer application is a computer game (e.g., a mobile game, a game for a dedicated gaming console, a massively multiplayer online game, a browser game, a game embedded in a social media platform, an augmented or virtual reality game, etc.). Another example application may be a traditional computer application executed on a desktop, laptop, tablet, or the like.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise includes one or more machine-learned intervention selection models 140. For example, the machine-learned intervention selection models 140 can be or can otherwise include various machine-learned models such as neural networks (e.g., deep recurrent neural networks) or other multi-layer non-linear models. The machine-learned intervention selection models 140 can include other types of models as well such as, for example, decision tree-based models (e.g., random forests), support vector machines, various types of classifier models, linear models, and/or other types of models.

The server computing system 130 can also include a computer application 142. The computer application 142 can include various different computer programs, software, and/or systems. One example application is a mobile application such as, for example, a text messaging application installed on a mobile device (e.g., smartphone). A developer or other entity involved with providing the mobile application may seek to maximize the number of users (e.g., daily users) of the mobile application or, stated differently, may seek to minimize user churn out of the mobile application. Another example of a computer application is a website. For example, a website owner may seek to maximize the number of users that “visit” or otherwise interact with her website on a periodic basis (e.g., daily, weekly, etc.). Another example of a computer application is a computer game (e.g., a mobile game, a game for a dedicated gaming console, a massively multiplayer online game, a browser game, a game embedded in a social media platform, an augmented or virtual reality game, etc.). Another example application may be a traditional computer application executed on a desktop, laptop, tablet, or the like.

The server computing system 130 can train the machine-learned intervention selection models 120 or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 140 stored at the server computing system 130 using various training or learning techniques, such as, for example, backwards propagation of errors. In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train a machine-learned intervention selection model 140 based on a set of training data 142. The training data 142 can include, for example, a set of user histories and interventions that were selected based on such user histories. The training data can include a respective ground-truth label for each pair of user history/intervention that describes a known outcome that occurred after the intervention. The training data 142 can also include rewards determined for certain actions.

In some implementations, if the user has provided consent, the training examples can be provided by the user computing device 102 (e.g., based on communications previously provided by the user of the user computing device 102). Thus, in such implementations, the model 120 provided to the user computing device 102 can be trained by the training computing system 150 on user-specific communication data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 1A illustrates one example computing system that can be used to implement the present disclosure. Other computing systems can be used as well. For example, in some implementations, the user computing device 102 can include the model trainer 160 and the training dataset 162. In such implementations, the machine-learned intervention selection models 120 can be both trained and used locally at the user computing device 102. In some of such implementations, the user computing device 102 can implement the model trainer 160 to personalize the machine-learned intervention selection models 120 based on user-specific data.

FIG. 1B depicts a block diagram of an example computing device 10 that performs intervention optimization according to example embodiments of the present disclosure. The computing device 10 can be a user computing device or a server computing device.

The computing device 10 includes a number of applications (e.g., applications 1 through N). Each application contains its own machine learning library and machine-learned intervention selection model(s). Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs intervention optimization according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned intervention selection model can be provided for each application and managed by the central intelligence layer. In other implementations, two or more applications can share a single machine-learned intervention selection model. For example, in some implementations, the central intelligence layer can provide a single machine-learned intervention selection model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Methods

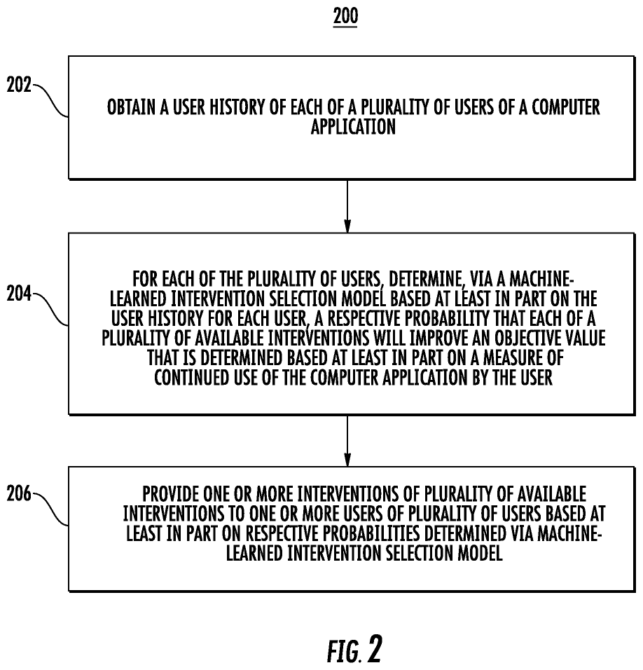

FIG. 2 depicts a flow chart diagram of an example method to perform intervention optimization according to example embodiments of the present disclosure. Although FIG. 2 depicts steps performed in a particular order for purposes of illustration and discussion, the methods of the present disclosure are not limited to the particularly illustrated order or arrangement. The various steps of the method 200 can be omitted, rearranged, combined, and/or adapted in various ways without deviating from the scope of the present disclosure.

At 202, a computing system can obtain a user history of each of a plurality of users of a computer application. For example, the computing system can obtain a history of events associated with the user in the computer application. The events can be events that the user triggered or events that were performed by or on behalf of the user. In some implementations, the history of events can be chronologically sorted. In some implementations, the user history can also include other contextual information (e.g., associated with certain events), such as, for example, time, current application state of the user's device, and/or other information regarding the user for which the user has consented that the application may use (e.g., user location). Thus, in some implementations, user history data for each user of a computer application can be a history of events that the user triggered or performed in the computer application, which may include a ‘time series’ of chronologically sorted events for that user.

At 204, the computing system can, for each of plurality of users, determine, via machine-learned intervention selection model based at least in part on the user history for each user, a respective probability that each of a plurality of available interventions will improve an objective value that is determined based at least in part on a measure of continued use of the computer application by the user. In some implementations, in addition to the measure of continued use of the computer application by the user, the objective value is further determined based at least in part on an allocation of resources by the user within the computer application. For example, the machine-learned intervention selection model can compute a respective probability that each of the plurality of available interventions will enable users to allocate resources in the computer application based on respective history of events associated with users.

More specifically, in some implementations, the machine-learned intervention selection model can provide predictions which correspond to the following values: More specifically, in some implementations, the machine-learned intervention selection model can provide predictions which correspond to the following values:

P(C=yes|T,I₀=yes), P(C=yes|T,I₁=yes), P(C=yes|T,I_{Z}=yes) . . . P(C=yes|T,I_{N}=yes),

where C is whether the user has churned out of the computer application, T the time series for the user, and I is a possible intervention the developer could take to reduce the chance that a user will churn. The I₀ intervention is the ‘null intervention’ in which the application's default behavior is given. Once each of these probabilities is computed, the computing system can select the intervention with the lowest probability of churn for the user and can then automatically apply the selected intervention to that user. That is, in some implementations, if the system has N possible interventions (including the null intervention), the system can choose and apply an invention according to the following example expression:

Argminᵢ(P(C=yes|T,Iᵢ)),0≤i≤N.

At 206, the computing system can provide one or more interventions of plurality of available interventions to one or more users of plurality of users based at least in part on respective probabilities determined via machine-learned intervention selection model. For instance, the computing system can select one or more interventions that are predicted to get users to stay in a computer application (e.g., a mobile application, a web browser application, or a game application), or to get users to spend money in the computer application. The computing system can provide the selected interventions to one or more users.

In some implementations, the computing system can operate to perform exploration versus exploitation of intervention strategies. More particularly, in order to know the impact of an intervention, the system typically needs to have data that describes the impact of that intervention applied to users in the wild. Thus, to compute the impact of all the interventions, the system can operate to trigger these interventions before the impact of doing so is explicitly known. This assists in learning when each intervention should be applied.

In particular, in some instances, instead of computing the respective probabilities for the interventions, the computing system can randomly provide one or more of the plurality of available interventions to users during an exploratory time period (also referred to as an exploration stage). As one example, the computing system can randomly give the one or more interventions to users in the computer application for some period of time, e.g., for a week. As another example, the computing system can randomly give a first intervention of the one or more interventions to users for a first time period, e.g., several hours in a specific date. The computing system can randomly give a second intervention of the one or more interventions to users for a second time period, e.g., 4 days a week. The computing system can randomly give a third intervention of the one or more interventions to users for a third time period after the first and second interventions applied to users, e.g., 5 days after the first and the second interventions applied to users. By observing the outcomes of these exploratory interventions, the computing system can better assess subsequent opportunities to intervene in the computer application. The exploration period can be developer-defined and/or can be performed by the computing system according to various optimization techniques such as one or more multi-armed bandit techniques.

As described above, not all interventions that are defined in the system can be used at every single instance. For example, developer-defined rules can prevent recurring usage of particular intervention. For example, if the intervention is sending out a notification, then the system may be constrained to only send one notification per certain time period (e.g., 48 hours). As such, in some implementations, the computing system can identify which of a plurality of defined interventions are available at a particular time. The plurality of available interventions can be a subset of the plurality of defined interventions that satisfy one or more developer-supplied intervention criteria and/or other rules at a time of selection. The machine-learned intervention selection model or the system that executes upon its predictions can be configured to select only available interventions for use.

In some implementations, the method 200 can further include determining an outcome of the provided interventions, determining a reward based on the outcome, and modifying a policy of the machine-learned intervention selection model based at least in part on the reward in accordance with a reinforcement learning scheme.

In some implementations, the method 200 can further include determining an outcome of the provided interventions, labeling the user history and provided interventions with the outcome to form additional training data, and re-training the machine-learned intervention selection model using a supervised learning scheme based at least in part on the additional training data.

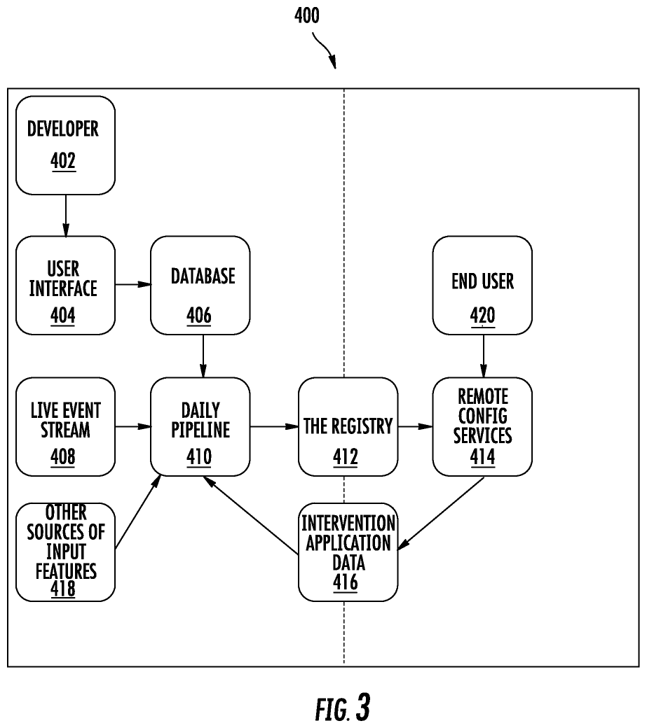

FIG. 3 depicts a block diagram of an example infrastructure 400 of a system that uses a machine-learned intervention selection model according to example embodiments of the present disclosure. As shown in FIG. 3, developer 402 can use a user interface 404 to enter a set of interventions and corresponding preferences (e.g., intervention name, remote configuration parameters, valid values, acceptable frequency, objective to be maximized, etc.). For each intervention, the user can define intervention name, remote configuration parameters to enable/disable the intervention, valid values, and acceptable frequency. The user can also define an objective (e.g., revenue, retention, custom) to be maximized.

The set of interventions and corresponding preferences can be stored in database 406 (e.g., a cloud database structure). A daily pipeline 410 can read in set of interventions and corresponding preferences, as well as user events from a live event stream 408, and other sources of input features 418 in training intervention selection models. During an exploration stage, the computing system can then determine a set of random users to apply interventions to and can record those choices in registry 412. Remote config services 414 (e.g., a cloud service that enables changes to the behavior and appearance of an application without requiring users to download an application update) can then read in the set of random users to apply those interventions to, and if those users 420 log in, the remote config services 414 can get the interventions applied to those users 420. The remote config services 414 can then record that the intervention was applied to the users 420, which it will then store in some dataset (e.g., intervention application data 416, the database 406 or the registry 412). The daily pipeline 410 can read in the intervention application data 416 to know which interventions were applied. During an exploration stage, the computer system will use a machine-learned intervention-selection model as described herein and the interventions selected by such model can be effectuated by the remote config services 414.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system, comprising:
one or more processors; and
one or more non-transitory computer-readable media that collectively store:
a machine-learned intervention selection model configured to select interventions on an entity-by-entity basis based at least in part on respective entity histories associated with entities; and
instructions that, when executed by the one or more processors, cause the computing system to perform operations, the operations comprising:
obtaining an entity history of each of a plurality of entities that use a computer application;
for each of the plurality of entities, determining, via the machine-learned intervention selection model based at least in part on the entity history for each entity, a respective probability that each of a plurality of available interventions will improve an objective value that is determined based at least in part on a measure of continued use of the computer application by the entity; and
providing one or more interventions of the plurality of available interventions to one or more entities of the plurality of entities based at least in part on the respective probabilities determined via the machine-learned intervention selection model.

2. The computing system of claim 1, wherein the computer application comprises at least one of: a mobile application, a web browser application, or a game application.

3. The computing system of claim 1, wherein the operations further comprise, prior to determining the respective probabilities, randomly providing one or more of the plurality of available interventions to the plurality of entities during an exploratory time period.

4. The computing system of claim 1, wherein the machine-learned intervention selection model is trained using supervised learning techniques.

5. The computing system of claim 1, wherein the machine-learned intervention selection model comprises an intervention agent in a reinforcement learning scheme.

6. The computing system of claim 1, wherein, in addition to the measure of continued use of the computer application by the entity, the objective value is further determined based at least in part on an allocation of resources by the entity within the computer application.

7. The computing system of claim 1, wherein at least some of the plurality available interventions are specified by a developer of the computer application.

8. The computing system of claim 1, wherein the operations comprise identifying the plurality of available interventions from a plurality of defined interventions, the plurality of available interventions being a subset of the plurality of defined interventions that satisfy one or more developer-supplied intervention criteria at a time of selection.

9. The computing system of claim 1, wherein the machine-learned intervention selection model is located within a server computing device that serves the computer application.

10. The computing system of claim 1, wherein the machine-learned intervention selection model is located within the computer application on a user computing device.

11. A computer-implemented method, comprising:
obtaining, by one or more computing devices, entity history data associated with an entity associated with a computer application;
inputting, by the one or more computing devices, the entity history data into a machine-learned intervention selection model that is configured to process the entity history data to select one or more interventions from a plurality of available interventions;
receiving, by the one or more computing devices, a selection of the one or more interventions by the machine-learned intervention selection model based at least in part on the entity history data; and
in response to the selection, performing, by the one or more computing devices, the one or more interventions for the entity.

12. The computer-implemented method of claim 11, wherein at least some of the plurality of available interventions are defined by a developer of the computer application.

13. The computer-implemented method of claim 11, wherein the machine-learned intervention selection model is configured to make the selection of the one or more interventions to optimize an objective function, wherein the objective function measures entity churn out of the computer application.

14. The computer-implemented method of claim 13, wherein the machine-learned intervention selection model is configured to determine a plurality of respective probabilities with which the plurality of available interventions will improve an objective value provided by the objective function, wherein the selection of the one or more interventions is based at least in part on the plurality of respective probabilities.

15. The computer-implemented method of claim 11, wherein the machine-learned intervention selection model comprises an intervention agent that learns via reinforcement learning.

16. The computer-implemented method of claim 11, wherein the machine-learned intervention selection model has been trained on a set of training data via supervised learning.

17. The computer-implemented method of claim 11, wherein the computer application comprises a mobile application, a gaming application, or a website.

18. The computer-implemented method of claim 11, further comprising:
performing, by the one or more computing devices, an exploration phase in which, for one or more other entities, one of the plurality of available interventions is selected randomly.

19. The computer-implemented method of claim 11, wherein performing, by the one or more computing devices, the one or more interventions comprises modifying, by the one or more computing devices, one or more operating parameters of the computer application.

20. One or more non-transitory computer-readable media that store instructions that, when executed by one or more computing devices, cause the one or more computing devices to perform operations, the operations comprising:
obtaining entity history data associated with an entity associated with a computer application;
inputting the entity history data into a machine-learned intervention selection model that is configured to process the entity history data to select one or more interventions from a plurality of available interventions, wherein at least some of the plurality of available interventions are defined by a developer of the computer application;
receiving a selection of the one or more interventions by the machine-learned intervention selection model based at least in part on the entity history data, wherein the machine-learned intervention selection model is configured to make the selection of the one or more interventions to optimize an objective function, wherein the objective function measures entity engagement with the computer application; and
in response to the selection, performing the one or more interventions for the entity within the computing application.
